(19) United States
(12) Patent Application Publication
(10) Pub. No.: US 2025/0186859 A1
(43) Pub. Date: Jun. 12, 2025

(54) Systems and Methods for Facilitating Yard Games

(71) Applicant: Vivint, Inc., Provo, UT (US)

(72) Inventors: Michelle Bea Zundel, Provo, UT (US); Erik Stephen Pfeiffer, Provo, UT (US)

(73) Assignee: Vivint, Inc., Provo, UT (US)

(21) Appl. No.: 18/972,904

(22) Filed: Dec. 7, 2024

Related U.S. Application Data
(60) Provisional application No. 63/607,291, filed on Dec. 7, 2023.

(51) Int. Cl. A63B 71/06

(52) U.S. Cl. CPC A63B 71/0622; A63B 2071/0625; A63B 2220/806; A63B 2225/74; A63B 2230/06

(57) ABSTRACT

Presented herein are system and methods to facilitate yard games. A system can include one or more sensors such as an image capture device, output devices, and one or more processors coupled with memory. The system can receive a request to initiate a game within an area. The system can provide, via the output devices, a first prompt based on the request to initiate the game and an entity within the area. The system can determine, based on attributes of the entity detected by the image capture device, actions of the entity related to the first prompt. The system can provide, via the output devices, a second prompt based on the request to initiate the game and the actions of the entity.

### CROSS-REFERENCE TO RELATED APPLICATIONS

This application claims priority to U.S. Provisional Patent Application No. 63/607,291 filed Dec. 7, 2023 which is incorporated by reference in its entirety.

### TECHNICAL FIELD

This application relates generally to systems and methods for facilitating outdoor activities. In particular, the present application relates to providing prompts for facilitating an outdoor activity, such as a yard game, through detected actions of an entity within an area.

### BACKGROUND

Entities enter into areas within a field of view of a camera, such as a property of a home protected by a security system. Entities, such as children, may play games within the field of view of the camera. The camera may not distinguish that the children are playing games and may identify the children as a threat. Furthermore, monitoring gameplay of children can be wearisome. Adult entities supervising children may grow bored or may not adequately understand the rules of the games played by the children. Furthermore, accurately determining winners or scores of games can be difficult due to varieties in rules of gameplay as well as the number of participating entities in the game causing lackadaisical adherence to the rules of the game.

### SUMMARY

The present disclosure is directed to systems and methods for facilitating an outdoor activity such as a yard game using a camera system. A camera system may detect entities, such as people or animals. In some cases, the entities can be children. The camera system can detect the entities, however the camera system may not perform any further actions responsive to the detection of the entities. For example, a detection of a child can elicit no response from the camera system or the same response that an adult would elicit form the camera system. The system may not monitor for a response received from the child entity and thereby may not configure the action for the child entity or acts performed by the child entity, thereby negating the functionality of the system. For example, the system can produce false positive alarms due to not identifying the entity, which detracts from efficiency of the system by wasting resources such as power used to produce an output or computational power. Furthermore, the system may fail to provide an action configured for the child entity, further negating the functionality of the system and wasting resources. Due to intrinsic behavioral and physical differences between adults and children, it would be desirable to have a camera system which can comport with the behavior of children and provide security, entertainment, or other measures aligned with children.

To address these and other technical challenges, a system can be configured to receive a request to initiate a game within an area. The system can provide a first prompt based on the request and an entity detected within the area (e.g., considering characteristics of the entity). The system can determine actions related to the first prompt, such as movements of the entity. By using a variety of sensors as well as image recognition and audio recognition techniques, the system can determine the actions performed by the entity. The system can determine to provide a second prompt based on the actions.

The system can receive a request to initiate a game within an area. The system can receive the request through a user interface, such as via a voice command or selection of a user interface button. The system can receive the request through observing or detecting an entity within the area. The system can provide a prompt through an output device coupled with the system. The prompt is based on the request to initiate the game. The request can identify a type of game, a duration of the game, a number of players of the game, a difficulty level of the game, among others. The system can identify, through facial recognition, voice recognition, gait analysis, or other such techniques, whether an entity performs actions related to the prompt. In some cases, the system can identify the entity as a recognized entity, such as an entity corresponding to a profile stored in a database of the system. In some cases, the system can determine, based on characteristics of the entity, whether the actions correspond to the prompt. Based on the action corresponding to the prompt, the system can provide a second prompt.

The system can provide the second prompt to continue the game. The second prompt can include instructions for continuation of the game. The second prompt can include an identification of a player (e.g., entity) of the game who is not in accordance with the first prompt. For example, the first prompt can include instructions for the entity to stay still. The system can detect that the entity does not stand still (e.g., moves) more than a threshold amount of movement. Based on the entity not conforming to the first prompt, the system can generate and provide the second prompt identifying the entity as not conforming to the first prompt. The second prompt may identify the entity as “out,” or no longer able to participate in the game. The second prompt can declare a winner, loser, or tie of the game, among others. The system can provide any one or more of a multitude of second prompts based on the actions of the entity related to the first prompt. The first or second prompt can include actuating any integrated subsystems (e.g., output devices), such as subsystems within a building like speaker systems, lighting systems, among others. In some cases, the system selects the one or more actions based on the determined criteria of the entity, such as selecting a prompt based on a subcategory of the entity.

In this manner, the system can provide for entities playing a game while simultaneously performing other security measures. The system can further actuate subsystems of the building outside of the area in which the entity is detected. The detection of the entity includes images, sensed measurements, or audio associated with the entity or the environment in which the entity is within. The system can determine a type of the entity from the detection and can determine one or more prompts to provide via one or more subsystems of the system. The actions can be configured for the entity and the game and updated based on a continuous monitoring of the entity's response to the prompts. The ability to generate a customized environment to facilitate games for entities reduces the waste of computational resources by reducing false-positive alarms as well as by providing a targeted response most in line with the intentions of the entity.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates a block diagram of an example system for facilitating yard games with a camera system.

FIG. 2 illustrates a flow diagram of an example system for facilitating yard games with a camera system.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for facilitating yard games with a camera system. A camera system can receive a request to initiate a game within an area. The camera system can provide a first prompt upon detecting an entity, such as a child, within an area. The camera system can determine actions related to the first prompt performed by the entity. Based on the actions performed by the entity, the camera system can determine a second prompt to provide to the entity.

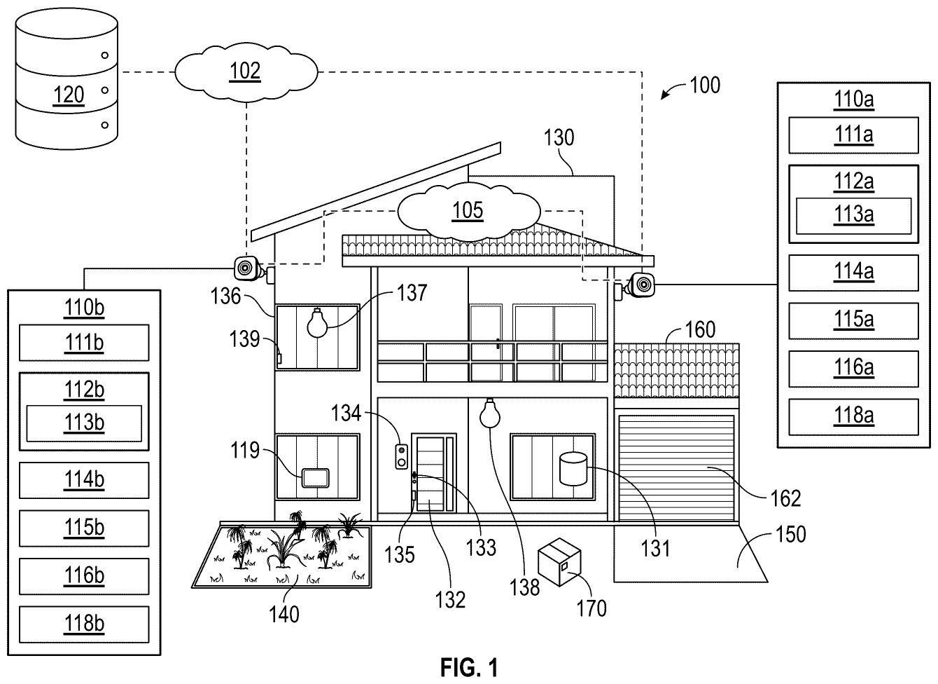

FIG. 1 illustrates an example environment 100 in which the present systems and methods may be implemented. The environment 100 may include a site that can include one or more structures, any of which can be a building 130 such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property or building. In an example, the environment includes a cul-de-sac including multiple homes.

The environment 100 may include a first camera 110a and a second camera 110b, referred to herein collectively as cameras 110. The cameras 110 may be attached to the building 130. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of light sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The environment 100 may include a user interface 119. The user interface 119 may be part of a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the cameras 110 may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 101. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the cameras 110 may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the cameras 110 are configured to play and/or otherwise emit one or more sounds in response to detecting the presence of a human within an area. For example, the cameras 110 may play one or more sounds selected to deter a detected person from an area around a building 101, property 101, and/or object. The cameras 110, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The camera 110, in some implementations, stores and/or has access to a library comprising a plurality of different sounds and/or a set of dynamically generated sounds so that the controller 106 may vary the different sounds over time, not using the same sound often. In some embodiments, varying and/or layering sounds allows a deter sound to be more realistic and/or less predictable.

One or more of the sounds may be selected to give a perception of human presence in the building 101, a perception of a human talking over an electronic speaker device, or the like which may be effective at preventing crime and/or property damage. For example, a library and/or other set of sounds may include audio recordings and/or dynamically generated sounds of one or more, male and/or female voices saying different phrases, such as for example, a female saying “hello?”, a female and male together saying “can we help you?”, a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like.

In some implementations, the cameras 110 may dynamically generate one or more sounds (e.g., using machine learning and/or other artificial intelligence, or the like) with one or more attributes that vary from a previously played sound. For example, the cameras 110 may generate sounds with different verbal tones, verbal emotions, verbal emphases, verbal pitches, verbal cadences, verbal accents, or the like so that the sounds are said in different ways, even if they include some or all of the same words. In some embodiments, the cameras 110 and/or a remote computer 125 may train machine learning on reactions of previously detected humans in other areas to different sounds and/or sound combinations (e.g., improving sound selection and/or generation over time).

The cameras 110 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The cameras 110, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the cameras 110 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the cameras 110 may play a primary sound layered and/or overlapping with one or more secondary, tertiary, and/or background sounds, varying the sounds and/or the combination from one or more previously played sounds and/or combinations, or the like.

The cameras 110, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The cameras 110, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the cameras 110 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the cameras 110 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120, may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may analyze or process images and/or radar data to detect an entity performing actions in accordance with a prompt. In some implementations, the cameras 110 may utilize the AI models 113 for processing and analyzing image and/or radar data.

In some implementations, the cameras 110 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

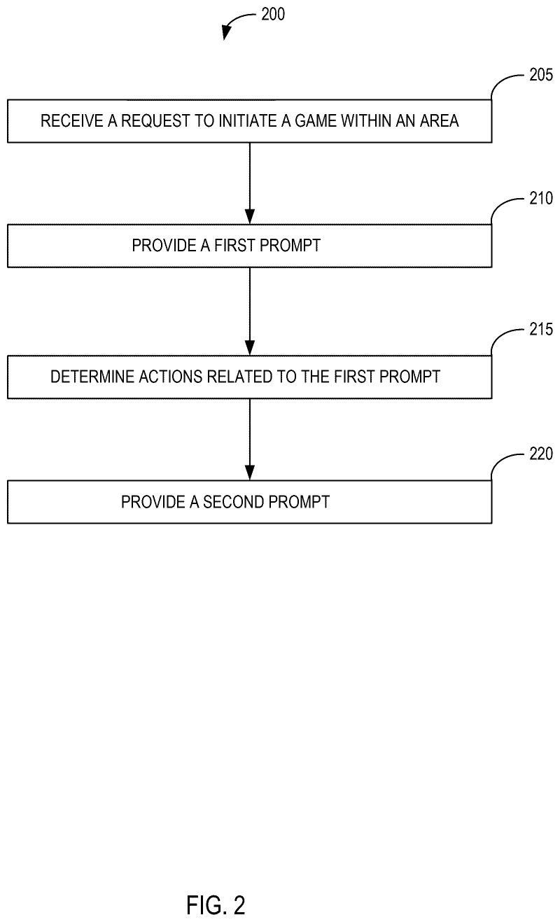

FIG. 2 depicts a flow diagram of a method 200 for facilitating an activity, with a camera system. The activity may be an outdoor activity, such as a yard game. The method 200 may be implemented or performed using any of the components detailed herein. Embodiments may include additional, fewer, or different operations from those described in the method 200. The operations may be performed in the order shown, concurrently, or in a different order. The method 200 may be performed by one or more components of the system 100. For example, the method 200 may be performed by the first camera 110a, the second camera 110b, or the cameras 110.

The system can receive a request to initiate an activity (e.g., a game) within an area (205). The system can receive the request to initiate a yard game in the area for an entity to play or participate in. A “yard game” or simply “game” can be or include a set of rules by which one or more entities abide for enjoyment during a period of time. The game can include scores, winners, losers, ties, or another method of determining a final outcome of the game. The game can be limited in duration (e.g., time) or rounds (e.g., matches), scores, among others. The games can include games such as Red Light Green Light, Simon Says, the Floor is Lava, racing games, hopscotch, Red Rover, Capture the Flag, SPUD, tag, hide and seek, sporting games (e.g., soccer, baseball, football), yard games (e.g., cornhole, horseshoes, croquet), among other games. Each game can include a set of rules. The set of rules for each game can indicate parameters for the gameplay, such as durations, scoring functions, permissible and impermissible movements or actions by players of the game, a sequence of events of the game, allowable or off-limits areas for the game, among others.

As an illustrative example, the game “Red Light Green Light” can include a first set of rules. As a summary of gameplay, during “Red Light Green Light” an entity attempts to reach a point of interest faster than other entities participating in the game, however, movement is only permissible at certain instances of the game. The first set of rules can include a rule indicating that movement is permissible while a green light is actuated. The first set of rules can include a rule indicating that movement is impermissible while a red light is actuated. The first set of rules can include a rule that between a transition from a red light to a green light, or vice versa, the words “Red light, green light, one, two, three” must be spoken or played. Based on the set of rules and detected characteristics of the entities (described herein), the system can determine winners, losers, points, scores, etc., of the game of “Red Light Green Light.” In some cases, the system can identify one or more entities that have broken a rule of the game. The first set of rules can include consequences for breaking a rule of the game, such as instructing an entity to return to a starting point of the game (e.g., to move further from the point of interest).

As another illustrative example, the game “the Floor is Lava” can include a second set of rules. As a summary of gameplay, during “the Floor is Lava,” one or more entities attempt to avoid subareas of the area. The second set of rules can include rules related to permissible and impermissible subareas of the area for the one or more entities to step upon. For example, an entity may not step on a floor of a room, but elevated furniture (e.g., couches, tables, etc.) are permissible zones for stepping. Upon an entity stepping in an impermissible (e.g., “lava”) subarea, the system can identify the entity as “out,” or no longer able to participate in the game/losing.

The system may receive the games from one or more sources. In some cases, the system may access a database of games including rules or other attributes of the game. The system may download games to facilitate via the camera 110. The system can download games responsive to a selection from an entity, upon a determination that a new game is available for download, or upon a scheduled update for the system.

The area can be or include an area of the environment 100 in which an entity participates in a game. The area can include the first region of interest 140 or the second region of interest 150, among other areas of the environment 100. The area can include a lawn, driveway, court, pool, trampoline, room, or other such area. In some cases, the area can be defined by one or more lines included in the area, such as chalk or paint lines to depict a field, court, or area of gameplay. In some cases, the area can be defined by a type of surface, such as clay, tarmac, grass, among others. In some cases, the area can be defined by a perimeter from a point of interest, such as a goal post, pole, hole, among others. In some cases, the area can be defined by a fence. In some cases, the area can be defined by a user, such as homeowner, by selecting a perimeter or area using a map of the environment 100 displayed on the user interface 119.

The request can be received using the user interface 119. In some cases, an entity can select, using the user interface 119, a game from a list of games for the system to facilitate using the camera 110. In some cases, the system can identify the request from one or more images or videos captured by the camera 110. For example, the system can identify one or more entities playing a game of “Red Light Green Light” in the area and may identify the request to play the game from the ongoing game indicated in the images/video. In some cases, the system can identify or receive the request from a voice command, such as an entity saying “Begin Simon Says.” In some cases, the system can detect an object within the images from the camera 110 and may identify the request to initiate the game based on the object. For example, the system can detect a basketball from the images and may determine one or more games, such as basketball, HORSE, or knockout, from the monitoring.

As described herein, the request can indicate rules of the game. The request can indicate a duration of the game. For example, a voice command can include a time period for the game, such as “Play tag until dinnertime.” In this illustrative example, the system can determine to facilitate a game of tag until “dinnertime,” which may be indicated by a predetermined time defined in the system or by a further monitoring for “dinnertime” (e.g., for a voice calling “dinner!”, for an indication that an oven has been turned off in the building 130, among others). The request can indicate conditions for stopping or pausing gameplay. For example, the system may determine to stop gameplay upon a detection that one or more entities participating in the game is hurt, crying, confused, among others.

The request can come from an entity associated with a profile stored in the system. The profile may identify the entity by the identification methods described herein. The profile can include images of the entity, a voice of the entity, a type of the entity, an identification of the entity, or other such information gathered about the entity from at least the cameras and/or the sensors. The profile can include a schedule of the entity, as determined from the machine learning model described herein. In some cases, one or more profiles can be updated, added, modified, or deleted from at least the user interface 119. For example, a homeowner may add profiles of family members to the system via the user interface 119. The homeowner may assign actions associated with the games, such as defining thresholds for performance of actions during gameplay or different games available for play. In some cases, the homeowner can download (via the network 105) one or more games to be facilitated by the camera system.

The system can provide a first prompt (210). The system can provide, via one or more output devices, a first prompt based on the request to initiate the game and an entity within the area. In some cases, the system can provide the first prompt to provide via output devices of the building, such as output devices associated with subsystems of the building. A plurality of prompts provided during a yard game can each include instructions to actuate, cause, or otherwise initiate functionalities of subsystems of the building 130 or the environment 100.

The entity can be a person within the environment 100. In some cases, the entity can include multiple persons within the environment 100. The entity can be known or unknown to a homeowner, resident, or neighbor of the building 130. For example, the entity can include the mailman, a stranger, a child, a friend, a gardener, or a group of these people or other people. The entity can include a homeowner, resident, or neighbor of the building 130. In some cases, the entity can be a child, adult, or individual who wishes to play a yard game facilitated by the system. The entity can provide the request to initiate the game within the area and/or the entity can participate in the game. The system can detect the entity within an area of the environment, such as in the first region of interest 140 or the second region of interest 150, among others.

The system can detect the entity within the area by detecting at least one of physical characteristics of the entity or behavioral characteristics of the entity. In some cases, the system can determine from the images, or other measurements from the sensors of the environment 100, characteristics of the entity which correspond to a person. The physical or behavioral characteristics can include the person carrying or interacting with an object, such as a ball, bat, hat, kite, or other such objects. The characteristics may include the detected person making noises such as shouting, whispering, stomping, or speech. The characteristics may include the detected person engaging with a part of the building 130, such as the door 132, the e-lock 133, or the exterior light 138, among others. Physical characteristics which may correspond to an entity include a temperature of a region within the area, a shape of the entity, a size of the entity, a sound of the entity (e.g., a vocal pitch or tone), among others. Behavioral characteristics of the entity can include movements of the entity (e.g., a gait or gesticulation), a sound of the entity (e.g., a cadence of speech or a selection of words spoken), or other such behavioral characteristics described herein. In some cases, the system can determine, using a machine learning model described herein, whether an entity is a child or an adult.

Image processing may be utilized to detect or otherwise identify the entity within a field of view of a camera 110 or image data captured therefrom. In some embodiments, a machine-learning model may be trained and utilized to detect or otherwise identify the entity. The machine-learning model may be trained by applying the machine-learning model on historical data including image data of various persons in various clothing. In an example, a camera executing a machine-learning model may determine that an entity is wearing black pants and a black shirt. In an example, a camera executing a machine-learning model may determine that an entity is a mail carrier or a delivery driver. In an example, a camera executing a machine-learning model may determine that an entity is a male teenager. In an example, a camera executing a machine-learning model may determine an entity's identity using facial recognition and/or other characteristics. Determining the one or more characteristics of the entity may include determining one or more actions of the entity. In an example, a camera executing a machine-learning model may determine that an entity is attempting to hide from the camera. In an example, a camera executing a machine-learning model may determine that an entity has passed by a house multiple times. In an example, a camera executing a machine-learning model may determine that an entity is playing in the lawn.

In some cases, one or more entities can participate in the game. As described herein, the term “entity” can refer to or include one or more entities, such as one or more entities participating in the game facilitated by the camera system. In some cases, the prompt can identify a subset of the entities participating in the game. For example, the prompt can identify a subset of the entities who are not in accordance with one or more rules of the game. For example, the system may say “Tommy and Jenny are out” in response to Tommy and Jenny not conforming to a rule of the game as identified by the camera system. In some cases, the system can keep track of scores or points for each entity participating in a game or a subset of the entities participating in the game. For example, the system can identify a subset of entities are belonging to a first team of a game and the system can allocate points, keep track of a score, or otherwise maintain a scoring system during gameplay for the team.

The prompt can be generated or identified based on at least the game indicated in the request or the entity. The game indicated in the request can include aspects of the game such as rules of the game, a type of the game (e.g., baseball, racing, tag), a duration of the game, preferences input during the request for the game, among others. The system can generate or identify a prompt during gameplay based on any of the aspects of the game. The system can identify or select the prompt based on the detected characteristics of the entity. For example, the system can generate a prompt based on a detection of children between ages 4-6 differently than a prompt based on a detection of children between ages 10-12.

The system can detect the entity in the area using one or more image capture devices, such as the cameras 110, or another image sensor. The system can include one or more additional sensors, such as the various sensors of the environment 100 (e.g., the window sensor 139, the door sensor 135, radar sensor(s) 114, microphone(s) 118, among others). Through the methods described herein with reference to FIG. 1, the system can detect an entity using at least one of the cameras 110 and/or the various sensors (e.g., radar sensor(s) 114, microphone(s) 118, Bluetooth connectivity detector, WiFi connectivity detector). In some cases, the system can capture images of the entity using one or more of the cameras 110, the doorbell camera 134, or another camera of the system. The images can be any form of image, such as a video, still image, single or multiple frames of images, among others. In some cases, the images can include images in the visible light spectrum such as color or black and white images. In some cases, the images can include images in the invisible light spectrum, such as infrared or ultraviolet images.

The prompt can include one or more instructions provided to the one or more entities during gameplay. In some cases, the prompt can indicate to the entities the rules of gameplay, an identification of an entity, or a command as a part of gameplay. For example, during a racing game, the prompt can include a dictation of a countdown, such as “Three, two, one, go!” For example, the prompt can include instructions for a speaker to dictate rules of the game responsive to receiving the request for to initiate the game. The prompt can cause an actuation of one or more output devices. The prompt can generate or include instructions for the one or more output devices to actuate, perform an action, or otherwise act. For example, the prompt can cause a light source to blink, a sound to emit, a sprinkler system to turn on, among others, in accordance with the game.

The system can identify the prompts from one or more sources. For example, the system can identify a prompt by selecting the prompt from a library of prompts based on the game indicated in the request and the characteristics of the entity within the area. In some cases, the system can generate the prompt using one or more machine-learning models. A machine-learning model can take as input one or more aspects of the game or characteristics of the entity to determine a prompt. In some cases, the machine-learning model can be trained on historic data including various yard games, actions associated with yard games, or characteristics of entities playing yard games. For example, the machine-learning model can implement a large language model to generate an instruction to provide to entities playing the game. For example, the machine-learning model can implement object detection techniques to generate the prompt. As an illustrative example, the machine-learning model can perform image analysis to detect a ball being thrown in the air based on images/video captured by the camera 110. Upon the ball being thrown in the air and based on the game identified in the request being “SPUD,” the machine-learning model can generate instructions to actuate a speaker to say “Run!”

The system can provide the prompt through one or more output devices. The system can generate instructions to transmit over the local network 105 and/or the network 102 to actuate one or more output devices of the environment 100. The output devices can include devices and/or subsystems of the environment 100 that provide a function, produce an output, or can be otherwise actuated by instructions from the system, such as instructions generated by the camera 110 responsive to receiving a request to initiate a game.

The output devices may include any components of the environment 100. For example, the output devices may include the door 132, the e-lock 133, light sources (e.g., the exterior light 138, or the interior light 137, among others) the window 136, the speakers 116, the garage door 162, or other such output devices like a sprinkler system, pathway or garden lights, appliances of the building 130 (e.g., a coffee maker, oven, refrigerator, dehumidifier, etc.), a display of the building 130 (e.g., a projector or television), among others. The output devices may be a part of or included in a subsystem of the environment 100. A subsystem of the environment 100 can include a subsystem of the building 130, such as a heating ventilation air-conditioning (HVAC) system designed to regulate temperature, air flow, humidity, or the climate of the building 130 and the surrounding environment 100. A subsystem of the environment 100 can include a plumbing system designed to regulate water flow throughout the environment 130, such as to toilets, showers, bathtubs, sinks, hoses, or a sprinkler. A subsystem of the environment 100 can include a lighting system designed to control lights, light fixtures, or light sources of the environment 100, such as a porch light, spotlight, strobe light, the interior light 137, the exterior light 138, pathway lights, among others.

The output devices may provide the prompt using instructions generated by the system for performing the prompt via the output devices. The system may generate the instructions according to the characteristics of the entity, the prompt, or the aspects of the game, among others. For example, the system may generate the instructions to include a period of time to actuate an output device, an intensity (e.g., volume for an audio output, brightness for a light output, etc.) with which to provide the prompt, a frequency with which to provide the prompt, among others. For example, the prompt may include playing a noise from the speaker 116. The system can play the noise or any sounds at any volume, tone, or pitch. The system can play the noise for any duration. In some cases, the system can cause the output devices to actuate as a part of providing the prompt until detecting a stimulus, such as a change in a characteristic of the entity or the detection of a second entity. For example, the system can light a porch light until detecting that the entity has entered the building 130 via the door 132. For example, the system can emit a siren until an entity is detected to stop moving.

The system may actuate the output devices according to the rules of the game. In some cases, the rules of the game can indicate one or more output devices to actuate based on the characteristics of the entity or the aspects of the game indicated in the request, among others. For example, the rules of the game may indicate that a game of tag requires two or more entities. Upon a detection of only one entity within the area, the first prompt may include instructions to say, via the speaker, “You need one more friend to play tag.” For example, the rules of the game may indicate that a game of soccer requires a ball, and may identify, using image recognition techniques, that no ball is present in the area and may cause the speaker to dictate as a part of the first prompt “You'll need a ball for soccer!”

In some cases, the output devices include one or more speakers. The first prompt can include instructions to play sound, noise, voice, or generated or recorded message through the one or more speakers. In some cases, the first prompt can include instructions to play a sound including auditory instructions to perform an action. For example, the first prompt may actuate a speaker to say “Freeze!” in a game of “1, 2, 3, Freeze!” to indicate to the entities playing the game to stop movement. As an illustrative example, the first prompt may actuate a speaker to play music, and then to stop playing music to indicate to the entities playing the game to take a seat, during a game of “Musical Chairs.”

In some cases, the output devices include one or more light sources. The light sources can include the interior light 137 of the building 130 and/or the exterior light 138 of the building 130, among others. The first prompt can include instructions to cause the light source to actuate. The instructions can cause the light source to change in color. For example, the instructions can cause the light source to change from red, to green, to yellow, or to any other color. The instructions can cause the light source to change in intensity. For example, the instructions can cause the light source to increase or decrease in lumens, lux, or other forms of brightness/light intensity. The instructions can cause the light source to change in periodicity. For example, the instructions can cause a change in a frequency of the light source (e.g., from 60Hz to 30 Hz), to cause the light to strobe, blink, be steady, etc.

The system can provide the first prompt responsive to detecting the entity within the area. For example, the system can detect that the entity is within the area. The system can detect, from the characteristics of the entity within the area, that the entity is playing a game or about to start playing a game. The system can, responsive to determining that the entity is or to start playing a game, provide the first prompt. In some cases, the system can determine the request to initiate the game based on the detected characteristics of the entity and can provide the first prompt responsive to the detected characteristics indicating the request.

In some cases, the system can provide the first prompt upon the elapse of a threshold period of time from receiving request to initiate the game. For example, upon receiving the request, the system can wait or buffer for a threshold period of time to allow the one or more entities to prepare for the game, such as to assemble within the area. The system may wait until the threshold period of time after receiving the request has elapsed to provide the first prompt via the one or more output devices.

The system can determine actions related to the first prompt (215). The system can determine, based on attributes of the entity detected by the image capture device, actions of the entity related to the first prompt. The attributes of the entity can include the characteristics of the entity as described with reference to (205). The system can determine actions of the entity based on the attributes (e.g., characteristics) of the entity. The system can process the measurements from the various sensors of the environment 100 including the images captured by the cameras 110 to determine one or more actions of the entity. The actions of the entity can include running, jumping, sitting, standing, gesticulating, or remaining stationary, among others.

In some cases, determining the actions of the entity includes determining an identity of the entity. An identity of the entity can include a name, a profile associated with the entity, an identifier of a device associated with the entity (e.g., a MAC address or TMSI of a phone of the entity, among others), a vehicle associated with the entity, a piece of clothing worn by the entity, among others. In some cases, the speech or noises detected from the entity may identify the entity, such as through vocal pattern recognition techniques that associate a voice with an entity or by the entity self-identifying through speech (e.g., “It's me, Jane Doe”).

The actions can be determined from the one or more measurements. The one or more sensors of the environment 100 (e.g., the door sensor 135, the doorbell camera 134, the window sensor 139, the radar sensor 114, the image sensor 115, or the microphone 118) may detect measurements associated with the actions. For example, a first measurement within a range of temperatures, a second measurement within a range of heights, and a third measurement within a range of cadence can correspond to an action. For example, a detection by the sensors of a person moving within the area can constitute an action of the entity.

In some embodiments, image processing may be utilized to detect or otherwise identify actions of the entity. In some embodiments, a machine-learning model may be trained and utilized to detect or otherwise identify actions of the entity in the area as corresponding to the first prompt. The machine-learning model may be trained by applying the machine-learning model on historical data including image data of various objects and entities. In an example, a child may be identified, using a machine-learning model executed on a camera, standing on a lawn of the environment 100. In an example, a homeowner may be identified, using a machine learning model executed on a camera, approaching a porch of the house via a walkway. Determining the actions of the entity can include tracking movement of the entity into or within the area. In an example, a child can be identified, using a machine-learning model executed on a camera, by tracking the movement of the child across a lawn of the house. In an example, a neighbor can be identified, using a machine learning model executed on a camera, by tracking the movement of the neighbor down a walkway towards a porch of the house.

The actions of the entity may be identified as conforming to the first prompt or not, based on the movement of the entity within the area. For example, the actions of an entity may be identified as not conforming to the first prompt based on movements performed by the entity which do not match rules of the game indicated in the request, such as moving within a particular zone of the area, moving or not moving within a range of time, performing actions not indicated by the first prompt, among others. The actions of the entity may be identified based on a comparison of a face, movements, a voice, or other biometrics of the entity to a repository of known entities, such as performed by a machine-learning model executing facial or other recognition techniques. The cameras 110 may perform image recognition functions as described herein to identify the actions of the entity. For example, the cameras 110 may analyze the captured images for a gait of the entity, a face of the entity (e.g., by facial recognition), objects the entity may be carrying, among others as described herein. In some cases, the cameras 110 can identify features of the entity from the images. Features of the images can include an object carried by the entity, a facial profile or structure of the entity, biometrics of the entity, clothing worn by the entity, among others.

The system may determine from at least one of the measurements and/or images by the machine-learning model, that the actions of the entity corresponds to the first prompt. In some cases, the system may determine, by providing images to the machine learning model, that the actions correspond to the first prompt. In some cases, the system may determine that characteristics of the entity determined from image recognition techniques performed by the cameras executing a machine-learning model meet a threshold for actions corresponding to the first prompt. As an illustrative example, a first prompt corresponding to a game of “Simon Says” may be associated with characteristics related to actions indicated in the first prompt preceded by the phrase “Simon says.”, such as “Simon says raise your arms,” “Simon says spin around” “Simon say jump,” among others. Continuing with the example, the system may determine, based on the machine learning model, that the features meet a threshold number of features to identify the actions of the entity as corresponding to the first prompt. For example, upon the first prompt stating “Simon says spin around,” characteristics of the entity indicating movement, a face of the entity followed by the back of the head of the entity and followed by the face again, among other characteristics, can indicate that the actions of the entity conform to the first prompt.

One or more actions of the entity can correspond to the first prompt. In some cases, the first prompt can identify one or more actions for one or more entities to perform as a part of the game. For example, the first prompt can specify a subarea of the area for the entity to avoid (e.g., during a game of “the Ground is Lava”). The entity can perform an action to avoid or to touch the subarea. If the entity avoids the subarea, the actions of the entity can conform or agree with the first prompt. If the entity comes into contact with the subarea, the action of the entity cannot conform or disagree with the first prompt. As another illustrative example, the first prompt can cause a light to flash green during a game of “Red Light Green Light.” While the light flashes green, the entity may move within the area. Upon the first prompt causing the light to flash red, the entity may cease movement within the area or may continue movement within the area. Should the entity cease movement within a threshold period of time of the system actuating the red light, the actions of the entity conform with the first prompt. Should the entity continue movement outside the threshold period of time of the system actuating the red light, the actions of the entity do not conform or agree with the first prompt.

In some cases, the system can determine characteristics of the entity using radar detection. The camera 110, as described herein, can include radar detection capabilities by which the system can detect characteristics of the entity. For example, using radar detection, the system may identify movements of the chest, breathe patterns, or pulse zones of an entity. Based on the detections, the system can determine a heartrate or breathing rate of the entity.

In some cases, the system can determine the actions of a plurality of entities. In some cases, the games involve two or more entities. the two or more entities may not interact with each other, such as during a race game. In some cases, the entities may interact with each other, such as through physical contact or passing an object such as a ball. The system can determine different actions for each of the entities participating in the game. In some cases, the actions of one or more entities can include an interaction with another entity participating in the game. For example, an identified action of a first entity can include throwing a ball to a second entity.

The system can provide a second prompt (220). The system can provide, via the output devices, a second prompt based on the request to initiate the game and the actions of the entity. In some cases, the system can provide the second prompt based on aspects of the game as described herein and characteristics of the entity that depict an action performed responsive to the first prompt. In some cases, the system can provide the second prompt based on whether the entity performed an action which conformed to the first prompt or did not conform to the first prompt. For example, the entity can provide the second prompt including instructions to perform an action to continue the game based on the entity performing an action conforming to the first prompt. For example, the entity can provide the second prompt including instructions or an indication (e.g., via the lights, a siren noise, among others) that the entity has lost the game or is no longer included in the game.

The system may provide images of the entity, from the camera 110, to determine actions to include in the second prompt based on the actions identified by the entity responsive to the first prompt. The system may select one or more actions based on the characteristics of the detected entity. For example, the system may select, using the machine learning model, one or more actions to include in an instruction for the second prompt if the system detects that the entity has performed an action in response to the presentation of the first prompt. The system may provide the characteristics to the machine learning model to determine which, if any, of the actions to select. For example, the system may identify the actions to stop jumping based on an output from the machine-learning model indicating that the entity is jumping in response to the first prompt. In this illustrative example, the machine learning model may take as inputs a temperature of the entity, a gait of the entity, facial recognition of the entity, among others, to determine that the entity is presently jumping and to generate instructions to include in the second prompt to tell the entity to stop jumping.

The system may determine the second prompt to end the game or continue the game. For example, the system may determine, based on the request, that the duration of the game has been met or exceeded. As part of this illustrative example, the system may generate the second prompt including an indication of the conclusion of the game. The indication of the conclusion of the game can include speech, such as saying “Game Over.” The indication of the conclusion of the game can include an option to continue gameplay, by which the entity can select (via a UI device, vocal recognition, gestures, etc.) to continue to play. The indication of the conclusion of the game can identify a winner, loser, or final score of the game. For example, the indication of the conclusion of the game can include sound saying “Tom is the winner with 10 points.”

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer- readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
one or more sensors, including an image capture device;
output devices; and
one or more processors coupled with memory and configured to:
receive a request to initiate a game within an area;
provide, via the output devices, a first prompt based on the request to initiate the game and an entity within the area;
determine, based on attributes of the entity detected by the one or more sensors, actions of the entity related to the first prompt; and
provide, via the output devices, a second prompt based on the request to initiate the game and the actions of the entity.

2. The system of claim 1, wherein the one or more processors are configured to:
detect the entity within the area; and
provide the first prompt responsive to detecting the entity within the area.

3. The system of claim 1, wherein the output devices comprise a speaker and the first prompt comprises an auditory instruction to perform the actions.

4. The system of claim 1, wherein the output devices comprise a light source and the first prompt comprises changing a color of the light source.

5. The system of claim 1, wherein to determine the actions of the entity related to the first prompt comprises the one or more processors to determine actions of a plurality of entities and wherein the actions of the plurality of entities comprises the entity interacting with the plurality of entities.

6. The system of claim 1, wherein the one or more processors are configured to:
identify, responsive to providing the first prompt, an object within the area; and
determine the actions of the entity related to the object.

7. The system of claim 1, wherein a plurality of entities comprises the entity and wherein the first prompt identifies a subset of the plurality of entities.

8. The system of claim 1, wherein the actions of the entity comprise:
running, jumping, sitting, standing, gesticulating, or remaining stationary.

9. The system of claim 1, wherein the one or more sensors comprises a depth capture device, and wherein the one or more processors are configured to determine, based on attributes of the entity detected by the depth capture device, a heart rate of the entity.

10. The system of claim 1, wherein the one or more processors are configured to:
provide, via the output devices, the first prompt including an instruction for the entity to remain stationary;
determine, based on attributes of the entity detected by the image capture device, actions of the entity comprising movement; and
provide, via the output devices, the second prompt comprising an identification of the entity based on the actions of the entity comprising movement.

11. The system of claim 1, wherein the output devices comprise one or more of:
a light source;
a speaker;
a display device;
an appliance;
a lock;
an entrance; or
a water system.

12. The system of claim 1, wherein to identify the one or more actions, the one or more processors are configured to provide the attributes of the entity as inputs to a machine learning model.

13. A method comprising:
receiving, by one or more processors coupled with memory, a request to initiate a game within an area;
providing, by the one or more processors via output devices, a first prompt based on the request to initiate the game and an entity within the area;
determining, by the one or more processors, based on attributes of the entity detected by one or more sensors, actions of the entity related to the first prompt; and
providing, by the one or more processors via the output devices, a second prompt based on the request to initiate the game and the actions of the entity.

14. The method of claim 13, comprising:
detecting, by the one or more processors using the one or more sensors, the entity within the area; and
providing, by the one or more processors via the output devices, the first prompt responsive to detecting the entity within the area.

15. The method of claim 13, wherein the output devices comprise a speaker and the first prompt comprises an auditory instruction to perform the actions.

16. The method of claim 13, wherein the output devices comprise a light source and the first prompt comprises changing a color of the light source.

17. The method of claim 13, wherein determining the actions of the entity related to the first prompt comprises determining, by the one or more processors, actions of a plurality of entities and wherein the actions of the plurality of entities comprises the entity interacting with the plurality of entities.

18. The method of claim 13, comprising:
identifying, by the one or more processors via the one or more sensors, responsive to providing the first prompt, an object within the area; and
determining, by the one or more processors, the actions of the entity related to the object.

19. The method of claim 13, wherein a plurality of entities comprises the entity and wherein the first prompt identifies a subset of the plurality of entities.

20. The method of claim 13, comprising:
providing, by the one or more processors via the output devices, the first prompt including an instruction for the entity to remain stationary;
determining, by the one or more processors based on attributes of the entity detected by the one or more sensors, actions of the entity comprising movement; and
providing, by the one or more processors via the output devices, the second prompt comprising an identification of the entity based on the actions comprising movement.
